(19) United States
(12) Patent Application Publication
(10) Pub. No.: US 2026/0073742 A1
(43) Pub. Date: Mar. 12, 2026

(54) METHOD AND APPARATUS FOR INDOOR VEHICLE TEST OF ADB LAMP

(71) Applicant: Ford Global Technologies, LLC, Dearborn, MI (US)

(72) Inventor: Linsheng Chen, Novi, MI (US)

(21) Appl. No.: 18/828,497

(22) Filed: Sep. 9, 2024

(51) Int. Cl. G07C 5/08; B60Q 1/06; B60Q 1/30; B60W 60/00; G01M 11/02

(52) U.S. Cl. CPC G07C 5/0808; B60Q 1/06; B60Q 1/30; B60W 60/001; G01M 11/02

(57) ABSTRACT

A method and apparatus include a test road having a predefined length and a testing procedure that is comprised of a plurality of scenarios each having a predefined distance range, wherein at least one scenario has the predefined distance range being greater than the predefined length, and wherein the at least one scenario is divided into a plurality of test segments that are of lengths that are less than the predefined length. A test vehicle with at least one ADB lamp is in a fixed location on the test road. A data collection vehicle with a plurality of stimulus lamps and a plurality of sensors is movable on the test road relative to the test vehicle and collects ADB data for each test segment. One or more controllers receive ADB data from the data collection vehicle for each test segment and combines the ADB data from each test segment to provide one ADB test result for the at least one scenario.

### TECHNICAL FIELD

This disclosure relates generally to a method and apparatus for indoor testing an adaptive driving beam (ADB) lamp.

### BACKGROUND

Vehicles often include a ADB lamps that automatically adjust headlight beams in response to certain inputs. These types of lamps often require intensive certification processes.

### SUMMARY

An apparatus according to an exemplary aspect of the present disclosure includes, among other things: a test road having a predefined length; a testing procedure comprised of a plurality of scenarios each having a predefined distance range, wherein at least one scenario has the predefined distance range being greater than the predefined length of the test road, and wherein the at least one scenario is divided into a plurality of test segments of lengths that are less than the predefined length; a test vehicle with at least one ADB lamp, wherein the test vehicle is in a fixed location on the test road; a data collection vehicle with a plurality of stimulus lamps and a plurality of sensors, wherein the data collection vehicle is movable on the test road relative to the test vehicle and collects ADB data for each test segment of the plurality of test segments; and one or more controllers that receive ADB data from the data collection vehicle for each test segment of the plurality of test segments and combines the ADB data from each test segment to provide one ADB test result for the at least one scenario.

In a further non-limiting embodiment of any apparatus, the test road is located within an indoor facility.

In a further non-limiting embodiment of any apparatus, the data collection vehicle is autonomously driven via a programmable machine.

In a further non-limiting embodiment of any apparatus, the plurality of stimulus lamps comprise one or more head lamps and one or more tail lamps.

In a further non-limiting embodiment of any apparatus, the test vehicle includes at least one vehicle sensor responsive to the one or more head lamps or the one or more tail lamps.

In a further non-limiting embodiment of any apparatus, the at least one vehicle sensor comprises at least one camera.

In a further non-limiting embodiment of any apparatus, the plurality of test segments includes: at least a first segment and a second segment, the first segment having an initial starting position for the data collection vehicle and a stopping position for the data collection vehicle; and the second segment having a shifted starting position that is shifted relative to the initial starting position for the first segment to maintain a perceived camera angle that would be experienced during a non-segmented test run for the at least one scenario.

In a further non-limiting embodiment of any apparatus, the test road comprises a first lane and a second lane separated by a dividing line, and wherein the test vehicle is in a fixed position in the first lane and the data collection vehicle moves along the second lane toward the test vehicle during the first segment, and wherein the shifted starting position for the second segment is shifted in a direction toward the first lane.

In a further non-limiting embodiment of any apparatus, the plurality of test segments includes at least a first segment for a first predefined length corresponding to a first portion of the predefined distance range and a second segment for a second predefined length corresponding to a second portion of the predefined distance range that is farther away from the test vehicle than the first portion, and wherein the one or more controllers apply a weighting factor to adjust an illuminance value for the second segment to correspond an illuminance value that would be experienced at the second portion of the predefined distance range for a non-segmented test run for the at least one scenario.

An apparatus according to an exemplary aspect of the present disclosure includes, among other things: a test road having a predefined length, wherein the test road is located within an indoor facility; a testing procedure comprised of a plurality of scenarios each having a predefined distance range, wherein at least one scenario has the predefined distance range being greater than the predefined length, and wherein the at least one scenario is divided into a plurality of test segments that are of lengths that are less than the predefined length; a test vehicle with at least one ADB lamp, wherein the test vehicle is in a fixed location on the test road; a data collection vehicle autonomously driven via a programmable machine and including a plurality of stimulus lamps and a plurality of sensors, wherein the data collection vehicle is movable on the test road relative to the test vehicle and collects ADB data for each test segment of the plurality of test segments; the plurality of stimulus lamps comprising one or more head lamps and one or more tail lamps; the test vehicle including at least one vehicle sensor responsive to the one or more head lamps or the one or more tail lamps; and one or more controllers that receive ADB data from the data collection vehicle for each test segment of the plurality of test segments and combines the ADB data from each test segment to provide one ADB test result for the at least one scenario.

In a further non-limiting embodiment of any apparatus, the plurality of test segments includes: at least a first segment and a second segment, the first segment having an initial starting position for the data collection vehicle and a stopping position for the data collection vehicle; and the second segment having a shifted starting position that is shifted relative to the initial starting position for the first segment to maintain a perceived camera angle that would be experienced during a non-segmented test run for the at least one scenario.

In a further non-limiting embodiment of any apparatus, the test road comprises a first lane and a second lane separated by a dividing line, and wherein the test vehicle is in a fixed position in the first lane and the data collection vehicle moves along the second lane toward the test vehicle during the first segment, and wherein the shifted starting position for the second segment is shifted in a direction toward the first lane.

In a further non-limiting embodiment of any apparatus, the plurality of test segments includes at least a first segment for a first predefined length corresponding to a first portion of the predefined distance range and a second segment for a second predefined length corresponding to a second portion of the predefined distance range that is farther away from the test vehicle than the first portion, and wherein the one or more controllers apply a weighting factor to adjust an illuminance value for the second segment to correspond to an illuminance value that would be experienced at the second portion of the predefined distance range for a non-segmented test run for the at least one scenario.

A method according to an exemplary aspect of the present disclosure includes, among other things: providing a test road having a predefined length; providing a testing procedure comprised of a plurality of scenarios each having a predefined distance range, wherein at least one scenario has the predefined distance range being greater than the predefined length, and wherein the at least one scenario is divided into a plurality of test segments that are of lengths that are less than the predefined length; fixing a test vehicle with at least one ADB lamp in a fixed location on the test road; moving a data collection vehicle with a plurality of stimulus lamps and a plurality of sensors on the test road relative to the test vehicle; collecting ADB data for each test segment of the plurality of test segments from the plurality of sensors; and receiving ADB data from the data collection vehicle for each test segment of the plurality of test segments and combining the ADB data from each test segment to provide one ADB test result for the at least one scenario.

In a further non-limiting embodiment of any method, the method includes locating the test road within an indoor facility.

In a further non-limiting embodiment of any method, the method includes autonomously driving the data collection vehicle via a programmable machine.

In a further non-limiting embodiment of any method, the plurality of stimulus lamps comprise one or more head lamps and one or more tail lamps, and the method includes providing at least one vehicle sensor o the test vehicle that is responsive to the one or more head lamps or one or more tail lamps.

In a further non-limiting embodiment of any method, the plurality of test segments includes at least a first segment and a second segment, the first segment having an initial starting position for the data collection vehicle and a stopping position for the data collection vehicle, and the method includes: maintaining a perceived camera angle that would be experienced during a non-segmented test run for the at least one scenario by shifting the second segment to a shifted starting position that is shifted relative to the initial starting position for the first segment.

In a further non-limiting embodiment of any method, the test road comprises a first lane and a second lane separated by a dividing line, and wherein the test vehicle is in a fixed position in the first lane and the data collection vehicle moves along the second lane toward the test vehicle during the first segment, and wherein the shifted starting position for the second segment is shifted in a direction toward the first lane.

In a further non-limiting embodiment of any method, the plurality of test segments includes at least a first segment for a first predefined length corresponding to a first portion of the predefined distance range and a second segment for a second predefined length corresponding to a second portion of the predefined distance range that is farther away from the test vehicle than the first portion, and the method includes: applying a weighting factor to adjust an illuminance value for the second segment to correspond to an illuminance value that would be experienced at the second portion of the predefined distance range for a non-segmented test run for the at least one scenario.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1A is a schematic illustration of a vehicle with ADB lamps approaching an oncoming vehicle.

FIG. 1B is a schematic illustration of a vehicle with ADB lamps approaching another vehicle that is driving in front of the vehicle with ADB lamps.

FIG. 2 shows one example table of ADB Photometry Requirements.

FIG. 3 shows an example table of an ADB System Test Matrix.

FIG. 4 is a schematic illustration of a test vehicle with ADB lamps and sensors.

FIG. 5 is a schematic illustration of a data collection vehicle with stimulus lamps and sensors.

FIG. 6 is a schematic illustration of a test road example for segments 1 and 3 of the first scenario.

FIG. 7 is a schematic illustration of a test road example for segment 2 of the first scenario.

FIG. 8 shows an example graph of a glare threshold over the test distance, e.g., illuminance v. distance, for the first scenario.

### DETAILED DESCRIPTION

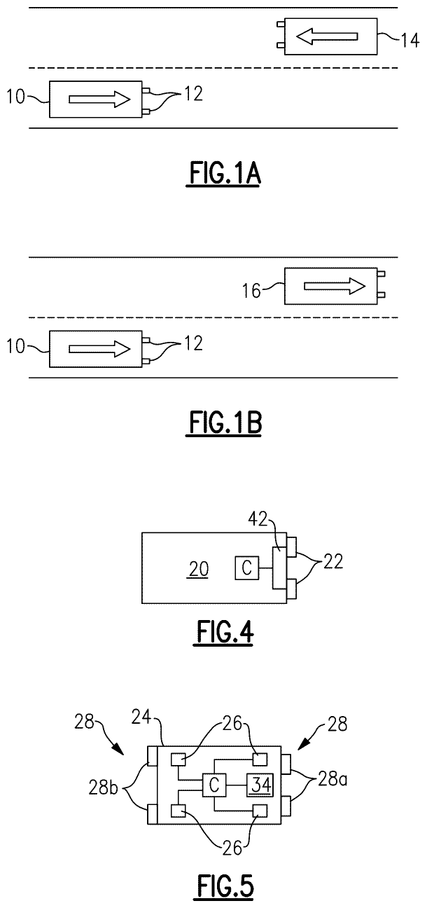

This disclosure details a method and apparatus for indoor testing an adaptive driving beam (ADB) lamp. FIG. 1A shows an example of a vehicle 10 with ADB lamps 12 approaching an oncoming vehicle 14. FIG. 1B shows an example of the vehicle 10 with ADB lamps 12 approaching another vehicle 16 that is driving in front of the vehicle 10 with ADB lamps 12.

ADB technology is a sophisticated feature provided in headlights that enhances nighttime driving by automatically adjusting headlight beams for situations like that shown in FIGS. 1A-B. This system increases visibility, and the ADB system uses sensors and cameras to detect road signs, oncoming vehicles, the presence of vehicles located on the road in front of an associated vehicle, and other environmental factors. In implementations, based on collected data, the ADB system provides dynamic light control by adjusting a shape and range of the headlights. For example, it can reduce the intensity of the high beam where it detects oncoming traffic or adjust the beam pattern to better illuminate curves and road edges. By continuously adjusting the headlights, the ADB system provides optimal illumination for different driving conditions, reducing glare and improving visibility.

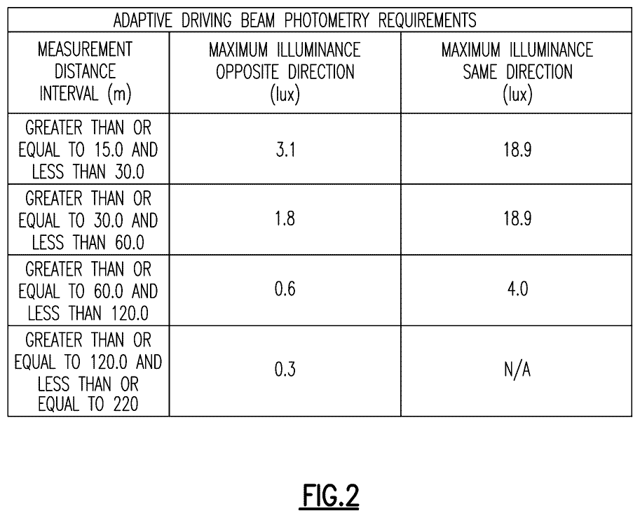

These ADB lamps 12 often require intensive certification processes. FIG. 2 shows one example table of ADB Photometry Requirements. This table details maximum illuminances for different directions, e.g. opposite direction and same direction, for various distance intervals.

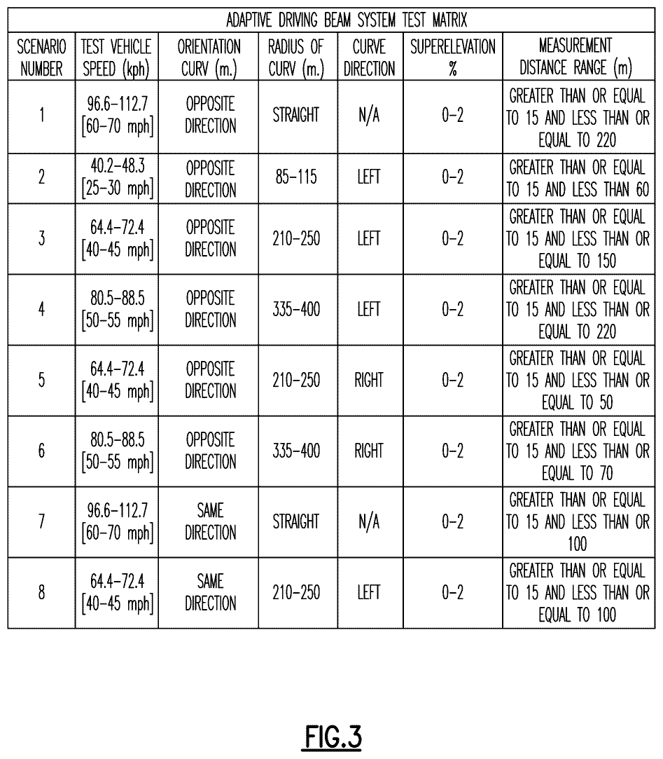

FIG. 3 shows an example table of an ADB System Test Matrix. This table details eight different test scenarios. In this example, each scenario includes a vehicle speed range, vehicle orientation, radius of curvature range, curve direction, super elevation percentage, and distance range.

In implementations, in order to certify an ADB lamp 12, the lamp should satisfy the ADB Photometry Requirements of the table of FIG. 2 and the vehicle road test as set forth in the table of FIG. 3. Additional road test requirements may include any of the following: the test road having a longitudinal grade (slope) that does not exceed 2%; testing should be conducted on dry pavement with no precipitation; and testing should be conducted when the ambient illumination at the test road as recorded by the sensors, e.g., photometers, is at or below 0.2 lux.

As such, running the ADB vehicle test is complicated, time-consuming, and expensive process; and many factors need be controlled to have a valid test result. The subject disclosure provides a test for the ADB lamp 12 that reduces expense and which can be conducted indoors at any time of the day. In implementations, the subject test is used as precursor to having the ADB lamp officially certified. This allows for evaluations and adjustments to be made prior to conducting the more complicated and expensive certification tests.

As shown in the vehicle road test table, the highest vehicle speed requirement is 60-70 mph and the longest road test distance is 220 meters. In order for a vehicle to reach 60-70 mph for an opposite direction, straight road test scenario, the road length should be longer than 220 meters. This is challenging to find as an indoor space. Additionally, it is challenging to run a test vehicle with ADB in a straight lane, as well as in a curved lane, in an indoor space. To address these issues, the subject disclosure reduces the test distance into several sub-segments such that the test is run in relatively small distances, with the test results from each segment being combined into one test result for each scenario. The test segments also accommodate straight and curved lane requirements.

In implementations, a test vehicle 20 (FIG. 4) is provided with ADB lamps 22 to be certified and a data collection vehicle 24 (FIG. 5) is provided with a plurality of sensors 26 and stimulus lamps 28, e.g., headlamps 28a, tail lamps 28b.

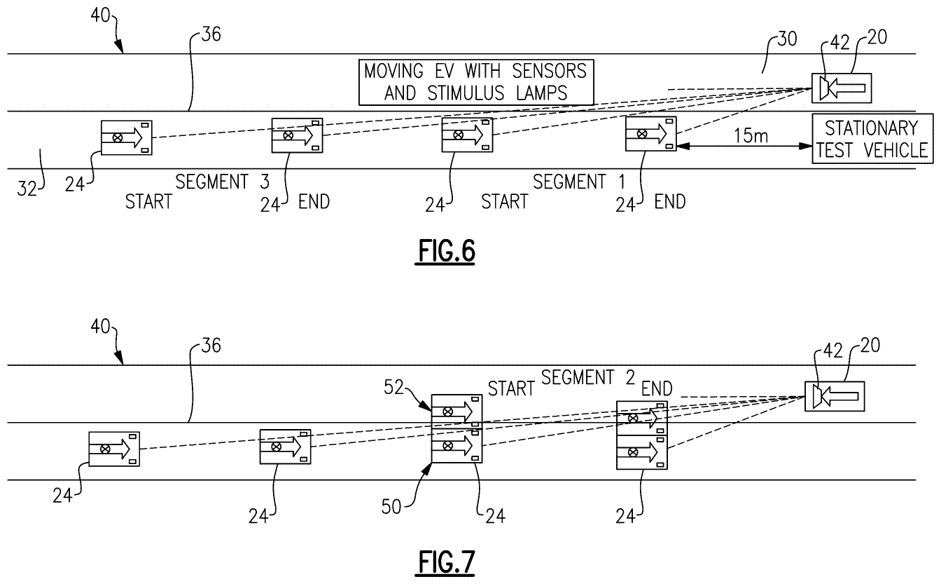

In implementations, the test vehicle 20 is fixed in position on a lane 30 as shown in FIG. 6 and the data collection vehicle 24 moves in a lane 32 toward the test vehicle 20. The lanes 30, 32 are separated by a dividing line 36. In one example, the data collection vehicle 24 comprises a small electrical vehicle (EV) such that exhaust is not emitted exhaust indoors. In implementations, a programmable machine 34 (FIG. 4), e.g., a robot, is designed and programmed to operate autonomously to drive the EV with consistent speed and track, and will eliminate possible human driver error. When the data collection vehicle 24 reaches the required speed range for the selected segment, the data collection vehicle 24 will go to a test starting point and run the test.

In implementations, the ADB lamps 22 on the test vehicle are enabled because an ADB system will be normally on when vehicle speed is above 20 miles per hour.

In implementations, all eight test scenarios can be run using the segmented method. Based on the different test lengths and road curvatures, each test scenario will have a different set of test segments. In implementations, GPS will be used to set the position of the data collection vehicle 24 and the programmable machine 34 will be used to drive the data collection vehicle 24 with the test sensors 26 and stimulus headlamps/tail lamps 28. In implementations, all test scenarios may be programed and run automatically via the use of one or more controllers C. Those skilled in the art who have the benefit of this description will be able to determine the programming requirements that would be applied for these purposes.

The first scenario will be used as an example. In the first scenario, it is an opposite direction condition with a straight road, reaching a speed of 60-70 mph, and with a distance range of 15-220 meters. In implementations, this test scenario is cut into several different segments and various lane adjustments are made to keep the same camera angle position due to the shortened segments. In one example, an illuminance determination (E=I/d\hat{ }2) is made for each segment. “E” represents illuminance, “I” is equal to intensity, and “d” is for the distance between the sensor 26 and the ADB lamp 22. The different segment results will then be combined together (per E=I/d\hat{ }2) to form a combined complete test result for the first scenario.

In implementations, the test vehicle 20 with an ADB lamp 22 is parked in on a test road 40 (FIG. 6) in lane 30 and the ADB lamp 22 is enabled. The test road 40 is separated into several segments, e.g. segment 1, segment 2, segment 3, etc., per available test space (see FIGS. 6-7). In one example, the lane width may be any width from 3.05 m (10 ft) to 3.66 m (12 ft) with pavement markings, but the road 40 shall be free of retroreflective material or any other elements that may affect the outcome of the test.

For the first scenario, the test road 40 is separated into four segments due to the long overall length of the distance range. In one example, segment 1 may be 15 m to 60 m, segment 2 may be 60 to 105 m, segment 3 may be 105 to 150 m, and segment 4 may be 150 m to 195 m. As shown in FIG. 6, for segment 1, a sensor 42 (FIG. 4), e.g., a camera, on the test vehicle 20 will see stimulus lamps 28 with a bigger angle than segment 2. In implementations, the camera 42 will communicate with the one or more controllers C via a network to have the ADB lamps 22 open and close different pixels to block light going to a driver's eyes, e.g. a sensor 26 on the data collection vehicle 24.

In implementations, for segment 2 as shown in FIG. 7, the data collection vehicle 24 will drive on the same test road; however, due to the reduced segments the camera perceived angle will not match the angle that would occur for the real road test of the first scenario, e.g., a single test run along a straight road that is over 220 meters long. In order to address this issue, for segment 2, the data collection vehicle 24 will move to a new lane position to achieve the desired camera perceived angle. FIG. 7 shows the initial position 50 of the data collection vehicle 24 for segment 1 versus the vertically shifted lane position 52 for segment 2.

By moving the data collection vehicle 24 vertically, the vehicle is driving in a new lane for segment 2, e.g., a shifted lane relative to the fixed test vehicle 20, and will maintain the same camera angle for segment 2 that would be experienced in the outdoor road test.

In implementations, for any additional segments, e.g., segments 3+, the data collection vehicle 24 will shift lane position relative to the fixed test vehicle 20 to maintain the perceived camera angle.

Additionally, in implementations, for segment 2 and any subsequent segments, when the data collection vehicle 24 moves closer to the test vehicle 20 with the ADB lamps 22, the stimulus headlamp or tail lamp 28 will have a stronger illuminance on the camera 42 of the test vehicle 20. However, the camera 42 has large dynamic range, which should not affect the test result; but if there is some noticed effect, a neutral dense filter may be installed in front of the stimulus headlamp or tail lamp 28 as needed.

Additionally, in implementations, in segment 2 and after, the data collection vehicle 24 will move closer to the test vehicle 20, and the sensor 26 will receive a stronger illuminance than would occur in segment 2 in the outdoor road vehicle test. As such, the glare value received by sensor 26 may need to be adjusted in segments 2 and above. In implementations, a weighting factor may be established to adjust the sensor test value automatically. For example, in segment 1, when distance is 15 m, the illuminance (E) on the sensor will equal I/15\hat{ }2, where “I” is the luminous intensity from the ADB lamps 22 of the test vehicle 20. In segment 2, the 60 meter illuminance should be=I/60\hat{ }2; but as segment 2 moves to the segment 1 position, the data collection vehicle 24 is closer to the test vehicle 20 and the illuminance will artificially increase.

As such, the illuminance value can be adjusted per the weighting factor (E=I/d\hat{ }2). As discussed above, for the first scenario the base road segment 1 distance is 15-60 meters. The segment 2 distance is 60-105 meters, and after the sensor 26 measures the illuminance, the system controllers C will multiply the weighing factor automatically and calculate the real illuminance for the segment 2 distance of 60-105 meters. Thus, the illuminance value may be adjusted back to correspond to the distance at the outdoor test.

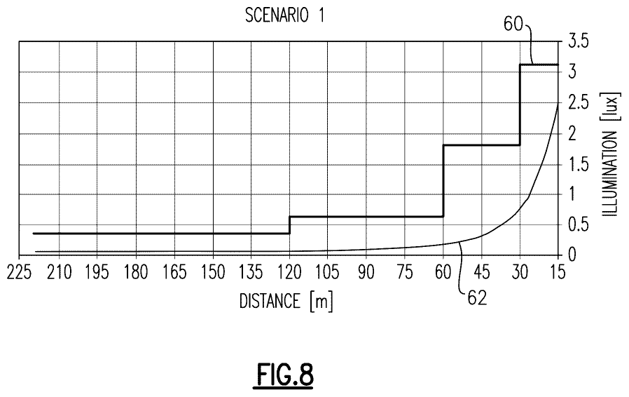

FIG. 8 shows an example graph of the glare threshold over the test distance, e.g., illuminance v. distance, for the first scenario as compared to the requirements. The upper stepped line 60 represents the ADB glare threshold for the requirements as set forth in the example table of FIG. 2. The lower line 62 represents the combined adjusted test glare values for all of the reduced test segments of the first scenario. As the lower line 62 is below the upper threshold line 60, it indicates that this test result meets the ADB requirement.

Once the first scenario has been completed, the remaining scenarios can be tested in succession in a manner similar to that which is described above with regard to first scenario.

Since the test vehicle with ADB lamp is stationary, the vehicle dynamic data will not be collected by using this indoor test method. Vehicle pitch and roll angle should be obtained based on the elevation profiles of the test track of all of test scenarios of the road test and vehicle dynamic from vehicle manufacturer, and these vehicle pitch and roll angle should be factored into indoor segment test data.

In implementations, once all segment tests are completed, the adjusted data will be combined into one test result for the first scenario. Note that for scenarios 2, 5, and 6, for example, the number of required segments may be reduced as these scenarios cover shorter distance ranges as compared to scenarios 1, 3, 4, and 7-8.

In implementations, once all segment tests are completed, any adjustments can be easily made to the ADB lamps 22 to make sure that the requirements will be satisfied for official certification. Once all adjustments have been made, the outdoor road test can be completed to self-certify the ADB lamps.

Those skilled in the art who have the benefit of this description will be able to determine the programming requirements for the one or more controllers C for the test vehicle 20 and the data collection vehicle 24 that would be applied for these purposes. The one or more controllers C can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The controllers may be a hardware device for executing software, particularly software stored in memory. The controllers can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

The controllers can be configured to execute software stored within the memory, to communicate data to and from the memory, and to generally control operations of the computing device pursuant to the software. Software in memory, in whole or in part, is read by the processor, perhaps buffered within the processor, and then executed.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An apparatus, comprising:
a test road having a predefined length;
a testing procedure comprised of a plurality of scenarios each having a predefined distance range, wherein at least one scenario has the predefined distance range being greater than the predefined length of the test road, and wherein the at least one scenario is divided into a plurality of test segments of lengths that are less than the predefined length;
a test vehicle with at least one ADB lamp, wherein the test vehicle is in a fixed location on the test road;
a data collection vehicle with a plurality of stimulus lamps and a plurality of sensors, wherein the data collection vehicle is movable on the test road relative to the test vehicle and collects ADB data for each test segment of the plurality of test segments; and
one or more controllers that receive ADB data from the data collection vehicle for each test segment of the plurality of test segments and combines the ADB data from each test segment to provide one ADB test result for the at least one scenario.

2. The apparatus of claim 1, wherein the test road is located within an indoor facility.

3. The apparatus of claim 1, wherein the data collection vehicle is autonomously driven via a programmable machine.

4. The apparatus of claim 1, wherein the plurality of stimulus lamps comprise one or more head lamps and one or more tail lamps.

5. The apparatus of claim 4, wherein the test vehicle includes at least one vehicle sensor responsive to the one or more head lamps or the one or more tail lamps.

6. The apparatus of claim 5, wherein the at least one vehicle sensor comprises at least one camera.

7. The apparatus of claim 1, wherein the plurality of test segments includes:
at least a first segment and a second segment, the first segment having an initial starting position for the data collection vehicle and a stopping position for the data collection vehicle; and
the second segment having a shifted starting position that is shifted relative to the initial starting position for the first segment to maintain a perceived camera angle that would be experienced during a non-segmented test run for the at least one scenario.

8. The apparatus of claim 7, wherein the test road comprises a first lane and a second lane separated by a dividing line, and wherein the test vehicle is in a fixed position in the first lane and the data collection vehicle moves along the second lane toward the test vehicle during the first segment, and wherein the shifted starting position for the second segment is shifted in a direction toward the first lane.

9. The apparatus of claim 1, wherein the plurality of test segments includes at least a first segment for a first predefined length corresponding to a first portion of the predefined distance range and a second segment for a second predefined length corresponding to a second portion of the predefined distance range that is farther away from the test vehicle than the first portion, and wherein the one or more controllers apply a weighting factor to adjust an illuminance value for the second segment to correspond an illuminance value that would be experienced at the second portion of the predefined distance range for a non-segmented test run for the at least one scenario.

10. An apparatus, comprising:
a test road having a predefined length, wherein the test road is located within an indoor facility;
a testing procedure comprised of a plurality of scenarios each having a predefined distance range, wherein at least one scenario has the predefined distance range being greater than the predefined length, and wherein the at least one scenario is divided into a plurality of test segments that are of lengths that are less than the predefined length;
a test vehicle with at least one ADB lamp, wherein the test vehicle is in a fixed location on the test road;
a data collection vehicle autonomously driven via a programmable machine and including a plurality of stimulus lamps and a plurality of sensors, wherein the data collection vehicle is movable on the test road relative to the test vehicle and collects ADB data for each test segment of the plurality of test segments;
the plurality of stimulus lamps comprising one or more head lamps and one or more tail lamps;
the test vehicle including at least one vehicle sensor responsive to the one or more head lamps or the one or more tail lamps; and
one or more controllers that receive ADB data from the data collection vehicle for each test segment of the plurality of test segments and combines the ADB data from each test segment to provide one ADB test result for the at least one scenario.

11. The apparatus of claim 10, wherein the plurality of test segments includes:
at least a first segment and a second segment, the first segment having an initial starting position for the data collection vehicle and a stopping position for the data collection vehicle; and
the second segment having a shifted starting position that is shifted relative to the initial starting position for the first segment to maintain a perceived camera angle that would be experienced during a non-segmented test run for the at least one scenario.

12. The apparatus of claim 11, wherein the test road comprises a first lane and a second lane separated by a dividing line, and wherein the test vehicle is in a fixed position in the first lane and the data collection vehicle moves along the second lane toward the test vehicle during the first segment, and wherein the shifted starting position for the second segment is shifted in a direction toward the first lane.

13. The apparatus of claim 10, wherein the plurality of test segments includes at least a first segment for a first predefined length corresponding to a first portion of the predefined distance range and a second segment for a second predefined length corresponding to a second portion of the predefined distance range that is farther away from the test vehicle than the first portion, and wherein the one or more controllers apply a weighting factor to adjust an illuminance value for the second segment to correspond to an illuminance value that would be experienced at the second portion of the predefined distance range for a non-segmented test run for the at least one scenario.

14. A method comprising:
providing a test road having a predefined length;
providing a testing procedure comprised of a plurality of scenarios each having a predefined distance range, wherein at least one scenario has the predefined distance range being greater than the predefined length, and wherein the at least one scenario is divided into a plurality of test segments that are of lengths that are less than the predefined length;
fixing a test vehicle with at least one ADB lamp in a fixed location on the test road;
moving a data collection vehicle with a plurality of stimulus lamps and a plurality of sensors on the test road relative to the test vehicle;
collecting ADB data for each test segment of the plurality of test segments from the plurality of sensors; and
receiving ADB data from the data collection vehicle for each test segment of the plurality of test segments and combining the ADB data from each test segment to provide one ADB test result for the at least one scenario.

15. The method of claim 14, including locating the test road within an indoor facility.

16. The method of claim 14, including autonomously driving the data collection vehicle via a programmable machine.

17. The method of claim 14, wherein the plurality of stimulus lamps comprise one or more head lamps and one or more tail lamps, and including providing at least one vehicle sensor o the test vehicle that is responsive to the one or more head lamps or one or more tail lamps.

18. The method of claim 14, wherein the plurality of test segments includes at least a first segment and a second segment, the first segment having an initial starting position for the data collection vehicle and a stopping position for the data collection vehicle, and including:
maintaining a perceived camera angle that would be experienced during a non-segmented test run for the at least one scenario by shifting the second segment to a shifted starting position that is shifted relative to the initial starting position for the first segment.

19. The method of claim 18, wherein the test road comprises a first lane and a second lane separated by a dividing line, and wherein the test vehicle is in a fixed position in the first lane and the data collection vehicle moves along the second lane toward the test vehicle during the first segment, and wherein the shifted starting position for the second segment is shifted in a direction toward the first lane.

20. The method of claim 14, wherein the plurality of test segments includes at least a first segment for a first predefined length corresponding to a first portion of the predefined distance range and a second segment for a second predefined length corresponding to a second portion of the predefined distance range that is farther away from the test vehicle than the first portion, and including:
applying a weighting factor to adjust an illuminance value for the second segment to correspond to an illuminance value that would be experienced at the second portion of the predefined distance range for a non-segmented test run for the at least one scenario.
